(19) United States
(12) Patent Application Publication
(10) Pub. No.: US 2026/0048887 A1
(43) Pub. Date: Feb. 19, 2026

(54) SYSTEMS AND METHODS FOR PROVIDING AUTOMATED APPLICATION OF TRAY TAG LABELS TO MAIL TRAYS

(71) Applicant: DMT Solutions Global Corporation, Danbury, CT (US)

(72) Inventors: John Robert Masotta, Newtown, CT (US); Boris Rozenfeld, Danbury, CT (US); Eddy Edel, New Milford, CT (US); Nicholas Aiken, Danbury, CT (US)

(21) Appl. No.: 19/302,772

(22) Filed: Aug. 18, 2025

Related U.S. Application Data
(60) Provisional application No. 63/684,008, filed on Aug. 16, 2024.

(51) Int. Cl. B65C 9/00; B65C 7/00; B65C 9/22; B65C 9/26; B65C 9/46

(52) U.S. Cl. CPC B65C 9/0015; B65C 7/00; B65C 9/2226; B65C 9/26; B65C 9/46; B65C 2009/0018

(57) ABSTRACT

The present invention provides automated systems and methods of affixing tray tag labels to mail trays in an automated fashion. The systems and methods of the present invention provide an economic, cost-efficient, and reliable means of affixing tag labels to mail trays.

### CROSS-REFERENCE TO RELATED APPLICATION

This application claims the benefit of, and priority to, U.S. Provisional Patent Application No. 63/684,008, filed Aug. 16, 2024, the content of which is incorporated by reference herein in its entirety.

### TECHNICAL FIELD

The present disclosure relates generally to mailpiece fabrication systems, and, more particularly, to a system for automated application of tray tag labels to mail trays for subsequent processing (i.e., placement of a given stack of finished mail into the trays, in which trays are then transported to a postage facility, such as United States Postal Service (USPS) or any other presorting and shipping facility).

### BACKGROUND

Direct mail is an important tool for businesses to communicate with customers. In various mass mailing preparations, a mail package may include one or more documents, which may be folded and/or combined with cards or other inserts, all of which must be inserted into an envelope, which is sealed, addressed, and stamped for mailing. As such, many businesses turn to mailpiece fabrication systems, such as mailpiece inserters and mailpiece wrappers, to periodically produce a large volume of mail.

Mailpiece fabrication systems are analogous to automated assembly equipment in that sheets, inserts and envelopes are conveyed along a feed path and assembled in, or at, various modules of the mailpiece fabrication system. For example, the typical inserter system resembles a manufacturing assembly line. Sheets and other raw materials (e.g., other sheets, enclosures, and envelopes) enter the inserter system as inputs. Then, a plurality of different modules or workstations in the inserter system cooperatively operate to process the sheets until a finished mailpiece is produced (i.e., contents of a given mailpiece are eventually placed within an envelope, package, or other carrier-type article and ready for mailing).

A finished mailpiece (also referred to as “finished mail” or “finished mailing”) generally undergoes further processing, which may include sorting and like, as well as eventual mailing to an intended recipient. For example, once a finished mailpiece has been prepared by the system, it may be grouped into a stack of other mailpieces and provided to a carrier service for delivery. As such, mailpieces or finished mail that is prepared from an inserter platform is generally placed within trays to be taken to a postage facility, such as United States Postal Service (USPS) or any other presorting and shipping facility.

In an effort to handle the processing of finished mailpieces more effectively, the USPS uses labels or tags (also referred to herein as “tray tag label” or “tag label”) to be applied to mail trays, wherein such labels or tags allow for unique identification of each tray traveling throughout the mail processing and delivery network. Each mail tray has a specifically marked area in which a plastic sleeve, for example, can be attached. The plastic sleeve will contain a printed label or tag. The location of the tag sleeve is determined by a USPS standard and cannot be changed.

There are two common methods of applying tray tag labels to mail trays. In a first method, the tag labels are pre-printed and an operator manually inserts the tag labels into sleeves attached to the mail trays prior to filling the tray with mailpieces. In this scenario, the proper tagging and sequencing of the trays must be arranged prior to starting the production run, as mail tray sequencing errors can result in sending mailpieces to the wrong destination. In a second method, the tray tag labels are pre-printed and an operator manually fills the tray with mailpieces and then inserts the tag label into the sleeve of the tray. The operator must then validate that the first mailpiece ID number matches the number printed on the tray tag label. This method is similar to the first method in that the operator has to ensure that the proper tagging is performed.

In both methods described above, because the operator manually fills the tray, there is no verification that the correct mailpieces are in the correct tray (i.e., verification that the first and the last mail piece IDs are correct), such that the integrity of a filled mail tray relies solely on the operator.

Furthermore, errors may occur as a result of the current methods of printing information on a given tag label. For example, the data printed on the tray tag label may be determined by a given IT application (corresponding to the current job), which consists of several USPS fields, adhering to the local postal requirements such as those of USPS, Royal Mail, LaPoste, etc. However, such information printed on the tag label will not be updated in case of process failures, wherein typical failures include, but are not limited to: 1) fewer mailpieces in the mail tray than expected (e.g., as a result of a jam or missing document from the primary input feeder); and 2) more mailpieces in the mail tray, where the file used to print the tray tag label did not match the inserter print file. Consequently, both the mail tray and the tray tag label are incorrect and require updating before induction into the postal mailstream.

Accordingly, relying on an operator to manage the placement of tray tag labels to given mail trays, either that have been previously filled with finished mail, or are to be subsequently filled with finished mail, may lead to errors thereby causing unpredictable workflow of the system and increased costs due to such errors.

### SUMMARY

The present invention addresses drawbacks of current tray tag label printing and application processes, specifically by providing a system configured to apply tray tag labels to mail trays in an autonomous manner.

In particular, the system of the present invention can generally be incorporated into an existing production mail inserter and processor (in which finished mail is produced and then placed in mail trays to then be transported to a postage facility and subsequently processed). For example, the system of the present invention may generally be in the form of a module comprising various elements for providing automated application of tray tag labels to mail trays. More specifically, the system generally includes a tray tag label inserter assembly configured to sequentially receive a supply of a plurality of tray tag labels and automatically insert each tray tag label into a corresponding one of a plurality of sleeves. The system further includes an applicator assembly operably coupled to the tray tag label inserter assembly and configured to automatically affix each sleeve (that has been loaded with a corresponding tray tag label) to a corresponding one of a plurality of mail trays.

The tray tag label inserter assembly may generally be loaded with a supply of a plurality of premade sleeves and is configured to position a given one of the plurality of premade sleeves into alignment with a pathway of the plurality of tray tag labels. For example, the plurality of tray tag labels may be provided to the tray tag label inserter assembly via a transport member (i.e., a conveyor belt, a series of rollers, a reciprocating pushing mechanism, etc). It should be noted that the transport member may be motorized.

The tray tag labels may either be printed on demand or be pre-printed and provided to the system. For example, in one embodiment, the system may include a printer operably coupled to the transport member and configured to print tray tag information on the plurality of tray tag labels on demand. In addition to printing tray tag information on the tray tag labels, the printer may also be configured to cut each of the plurality of tray tag labels to size. Accordingly, by incorporating a printer into the system (for on-demand printing of information for each tag) information on a given tag label can be used to introduce a feedback step to the process, enabling the updating of tray tag data with the correct information necessary for mail induction into the postal mailstream. This can be facilitated when trays are automatically filled using an automated device including tray tagging and printing.

The tray tag labels are moved along, in a serial fashion, towards to the tray tag label inserter assembly to then be inserted into a corresponding one of the plurality of sleeves. In a preferred embodiment, the transport member may include a pusher member provided between the printer and the tray tag label inserter assembly. The pusher member is configured to translate along a length of track in a reciprocating motion (i.e., in a substantially horizontal direction relative to the printer and the tray tag label inserter assembly). The pusher member is configured to engage an edge of a tray tag label from the printer and push the tray tag label towards the tray tag label inserter assembly and subsequently into a corresponding sleeve.

The tray tag label inserter assembly is configured to index each cycle of movement of the plurality of premade sleeves a distance equal to a width of each premade sleeve to thereby cause each premade sleeve to sequentially align with a corresponding one of the plurality of tray tag labels for subsequent insertion thereof.

The tray tag label inserter generally includes an actuating suction cup configured to engage and lift a top panel of a given one of the premade sleeves to thereby widen an opening of the given one of the premade sleeves. In some embodiments, the tray tag label inserter may also include an arm member that includes a flange (or finger-like member) configured to engage and cause movement of a corresponding one of the plurality of tray tag labels towards the opening and into the given one of the premade sleeves.

In some embodiments, the plurality of premade sleeves may include an adhesive backing covered by a liner such that, upon engagement of the applicator assembly with a loaded premade sleeve, liner is stripped from the loaded premade sleeve. However, in some embodiments, it should be noted that the system may include an adhesive applicator for applying an adhesive to a loaded premade sleeve prior to the applicator assembly affixing the loaded premade sleeve to the corresponding one of a plurality of mail trays.

The applicator assembly generally includes an articulating arm including an end effector at a distal portion thereof and having a suction member mounted thereto, the articulating arm being configured to move between a loading position and a delivery position.

When the articulating arm is in the loading position, the suction member is positioned proximate to a leading one of the plurality of sleeves loaded with a corresponding tray tag label and, upon application of a sufficient vacuum force, the suction member lifts the leading one of the plurality of sleeves loaded with a corresponding tray tag label into engagement therewith so as to allow subsequent conveyance thereof. When the articulating arm is in the delivery position, the suction member is brought into position relative to a corresponding one of the plurality of mail trays to thereby cause the leading one of the plurality of sleeves loaded with a corresponding tray tag label to engage and be affixed, via an adhesive, to a portion of a corresponding one of the plurality of mail trays. More specifically, when the articulating arm is in the delivery position, the vacuum force is released so as to allow the suction member to disengage from the leading one of the plurality of sleeves loaded with a corresponding tray tag label.

In one embodiment, the articulating arm comprises a first arm portion and a second arm portion coupled to one another. The first arm portion includes a first end rotatably coupled to a base and is configured to rotate about a first axis relative to the base. The second arm portion extends from a second end of the first arm portion and is configured to move between a retracted position and an extended position relative to the second end of the first arm portion. In particular, the articulating arm may include a linear actuator mechanism configured to move the second arm portion between the retracted and extended positions. The second arm portion includes the end effector provided at a distal end thereof, wherein the end effector includes the suction member mounted thereto.

When the articulating arm is in the loading position, the first and second arm portions are substantially aligned with one another and substantially parallel to the base, and the second arm portion is in the extended position. When the articulating arm is in the delivery position, the first and second arm portions are substantially aligned with one another and substantially perpendicular to the base, and the second arm is in the retracted position.

For example, when in the loading position, the second arm portion is in the extended position to thereby position the end effector (and suction member) over a sleeve loaded (or to be loaded) with a tray tag label. Vacuum is applied to the suction member (to thereby cause the suction member and sleeve to engage one another). The movement from the loading position to the delivery position is performed in the following motions: 1) the second arm portion moves from the extended position to the retracted position, in which the end effector is drawn towards the first arm portion and clears portions of the base and/or other portions of the assembly (the speed of retraction of the second arm portion may be the same, or substantially the same, as the speed at which the sleeves are advanced); 2) the first arm portion rotates about the first axis towards a perpendicular and lowered position relative to the base while maintaining the second arm portion in the retracted position so as to allow the second arm portion to clear portions of the base and/or other portions of the liner and tray tag label inserter assembly; and 3) the suction member is brought into position relative to a corresponding one of the plurality of mail trays to thereby cause the leading one of the plurality of sleeves loaded with a corresponding tray tag label to engage and be affixed, via an adhesive, to a portion of a corresponding one of the plurality of mail trays.

Similarly, movement from the delivery position to the loading position is performed in the following motions: 1) the first arm portion rotates about the first axis towards a substantially parallel position relative to the base while maintaining the second arm portion in the retracted position so as to allow the second arm portion to clear portions of the base and/or other portions of the assembly; and 2) the second arm portion moves to the extended position to thereby position the end effector (and suction member) over a sleeve loaded (or to be loaded) with a tray tag label.

In an alternative embodiment, the articulating arm comprises a first arm portion and a second arm portion rotatably coupled to one another. For example, the first arm portion includes a first end rotatably coupled to a base and is configured to rotate about a first axis relative to the base and includes a second opposing end rotatably coupled to a first end of the second arm portion. The second arm portion is configured to rotate about a second axis relative to the first arm portion. The suction member is mounted to the second arm portion, notably at a distal end thereof.

When the articulating arm is in the loading position, the first and second arm portions are substantially aligned with one another and substantially parallel to the base. When the articulating arm is in the delivery position, the first and second arm portions are substantially aligned with one another and substantially perpendicular to the base.

For example, movement from the loading position to the delivery position is performed in the following motions: 1) the second arm portion rotates about the second axis towards a perpendicular and elevated position relative to the first arm portion and the base; 2) the first arm portion rotates about the first axis towards a perpendicular and lowered position relative to the base while maintaining the second arm portion in said position so as to allow the second arm portion to clear portions of the base and/or other portions of the system; and 3) the second arm portion rotates about the second axis so as to become substantially aligned with the first arm portion and thereby cause the suction member to be brought into position relative to a corresponding one of the plurality of mail trays to thereby cause the leading one of the plurality of sleeves loaded with a corresponding tray tag label to engage and be affixed, via an adhesive, to a portion of a corresponding one of the plurality of mail trays.

Similarly, movement from the delivery position to the loading position is performed in the following motions: 1) the second arm portion rotates about the second axis towards a perpendicular position relative to the first arm portion; 2) the first arm portion rotates about the first axis towards a substantially parallel position relative to the base while maintaining the second arm portion in said position so as to allow the second arm portion to clear portions of the base and/or other portions of the system; and 3) the second arm portion rotates about the second axis so as to become substantially aligned with the first arm portion and substantially parallel relative to the base.

Accordingly, the system of the present invention provides an autonomous manner in which tray tag labels are affixed to mail trays, reducing risk of errors in the workflow and thereby improving economic and operational efficiency of labeling mail trays for subsequent processing (i.e., placement of a given stack of finished mail into the trays, in which trays are then transported to a postage facility, such as United States Postal Service (USPS) or any other presorting and shipping facility).

### BRIEF DESCRIPTION OF THE DRAWINGS

Features and advantages of the claimed subject matter will be apparent from the following detailed description of embodiments consistent therewith, which description should be considered with reference to the accompanying drawings.

FIG. 1 is a block diagram schematic of a document inserter and processing system in which the tray tag label applicator module of the present invention is operably coupled to.

FIG. 2 is a perspective view of an exemplary tray tag label applicator module incorporated within an existing production mail inserter and processor assembly, specifically positioned relative to a mailpiece loading module (for loading finished mail provided via a mailpiece stacking module into corresponding mail trays).

FIG. 3 is a perspective view of the tray tag label applicator module illustrating various components thereof.

FIG. 4 is an enlarged view showing portions of the tray tag label inserter assembly of the tray tag label applicator module in greater detail.

FIG. 5 is an enlarged view showing the articulating arm of the applicator assembly in greater detail, including illustrating the articulating arm in a loading position.

FIGS. 6 and 7 illustrate retraction of the end effector of the articulating arm (FIG. 6) and subsequent movement of the articulating arm from a loading position to a delivery position (FIG. 7) for subsequently affixing a sleeve loaded with a corresponding tray tag label to a corresponding one of a plurality of mail trays.

FIG. 8 shows the applicator assembly affixing a sleeve loaded with a corresponding tray tag label to a corresponding mail tray.

FIG. 9 is an enlarged view showing an exemplary embodiment of an end effector of the articulating arm having a cutting member providing thereon.

FIGS. 10-16 show an alternative embodiment of a tray tag label applicator module.

FIG. 10 is a perspective view of an exemplary alternative tray tag label applicator module consistent with the present disclosure.

FIG. 11 is a perspective view of the tray tag label applicator module of FIG. 10 illustrating various components thereof.

FIG. 12 is an enlarged view showing portions of the tray tag label inserter assembly of the tray tag label applicator module of FIG. 10 in greater detail.

FIG. 13 is an enlarged view showing the articulating arm of the applicator assembly of the tray tag label applicator module of FIG. 10 in greater detail.

FIGS. 14 and 15 illustrate movement of the articulating arm of the applicator assembly from a loading position to a delivery position for subsequently affixing a sleeve loaded with a corresponding tray tag label to a corresponding one of a plurality of mail trays.

FIG. 16 shows the applicator assembly affixing a sleeve loaded with a corresponding tray tag label to a corresponding mail tray.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

By way of overview, the present invention is directed to systems and methods for automated application of tray tag labels to mail trays for subsequent processing.

As previously described, the USPS uses labels or tags (also referred to herein as “tray tag label” or “tag label”) to be applied to mail trays, wherein such labels or tags allow for unique identification of each tray traveling throughout the mail processing and delivery network. Each mail tray has a specifically marked area in which a plastic sleeve, for example, can be attached. The plastic sleeve will contain a printed label or tag. The location of the tag sleeve is determined by a USPS standard and cannot be changed.

In conventional systems, human operator(s) are relied upon for affixing the application of tag labels to the mail trays. As such, a given operator has to ensure that the proper tagging is performed, such that the integrity of a filled mail tray is maintained (i.e., the proper finished mail is provided within a given mail tray and matches the data for the tag provided on that mail tray. The requirement of human operator(s) performing one or more of these steps may delay, slow down, or lead to errors in the workflow.

The present invention addresses drawbacks of current tray tag label printing and application processes, specifically by providing a system configured to apply tray tag labels to mail trays in an autonomous manner. In particular, the system of the present invention includes tray tag label applicator module generally configured be incorporated into an existing production mail inserter and processor (in which finished mail is produced and then placed in mail trays to then be transported to a postage facility and subsequently processed) and provide automated application of tray tag labels to mail trays for subsequent processing.

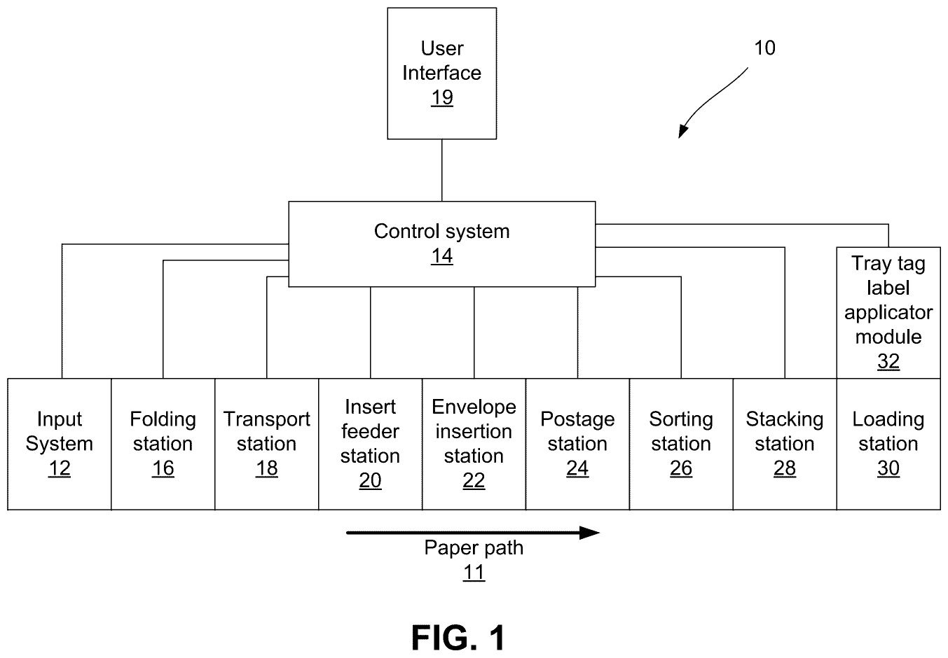

FIG. 1 is a block diagram schematic of an exemplary document insertion and processing system/platform in which the tray tag label applicator module of the present invention is operably coupled to. For example, the tray tag label applicator module can be incorporated into, or otherwise operably associated with, modular inserter and processing platforms, including, but not limited to, any one of the EVOLUTION™, MAILSTREAM EVOLUTION™, RIVAL™, and EPIC™ inserter platforms available from DMT Solutions Global Corporation dba BlueCrest (Danbury, CT).

For example, the document insertion and processing system 10 includes several stations or modules. The document insertion s and processing system 10 is illustrative and many other configurations may be utilized.

The system 10 includes an input system 12 that feeds paper sheets from a paper web to an accumulating station that accumulates the sheets of paper in collation packets. In some embodiments, only a single sheet of a collation is coded (the control document), which coded information can be one input into the control system 14. The control system includes a processor configured to execute instructions that control the processing of documents in the various stations of the mass mailing inserter system 10. The system 10 may include a user interface 19 for controlling one or more user inputs and displaying one or more outputs from the system 10, allowing a user to interact with and control the operation of the system, can be physically connected to the system or can be located remotely. The user interface 19 can include a screen such as a touchscreen configured to display operating conditions and parameters of the inserter system 10 to a user. The user interface 19 can include other input devices such as a keyboard/keypad or a mouse.

The input system 12 is configured to feed sheets in a paper path, as indicated by arrow 11, along what is known as the main deck of inserter system 10. After sheets are accumulated into collations by input system 12, the collations are folded in folding station 16 and the folded collations are then conveyed to a transport station 18, preferably operative to perform buffering operations for maintaining a proper timing scheme for the processing of documents in insertion system 10.

Each sheet collation is fed from the transport station 18 to an insert feeder station 20. It should be noted that an inserter system 10 may include a plurality of feeder stations, but for clarity, only a single insert feeder 20 is shown. The insert feeder station 20 is configured to convey an insert (e.g., an advertisement or the like) from a supply tray to the main deck of inserter system 10 so as to be combined with the sheet collation conveying along the main deck. The sheet collation along with nested insert(s) are next conveyed into envelope insertion station 22 that is operative to open an unsealed envelope and insert the collation into the opening of the envelope.

The filled envelope may then be conveyed to a station for sealing and/or rearranging the filled envelope for subsequent processing. For example, in some embodiments, the system 10 may include a sealing and flipping station that is operable to wet the adhesive substance on the flap of the envelope, rotate the envelope into a face-up orientation, and seal the envelope by pressing the flap against the body of the envelope. The filled and sealed envelope is then conveyed to postage station 24. In some embodiments, the envelope may then be conveyed to sorting station 26 that sorts the envelopes.

It should be noted that the inserter system 10 may include additional stations/modules for performing additional tasks. For example, mailpiece inserter systems may include a variety of apparatus/modules for conveying and processing a substrate/sheet material along the feed path, in addition to those stations/modules described herein. For example, inserter systems consistent with the present disclosure may further include apparatus/modules for: (i) accumulating printed content to form a multi-sheet collation in an “accumulator”; (ii) folding the content to produce a variety of fold configurations such as a C-fold, Z-fold, bi-fold and gate fold, in a “folder”; (iii) feeding mailpiece inserts such as coupons, brochures, and pamphlets, in combination with the content, in a “chassis module”; and (iv) printing recipient/return addresses and/or postage indicia on the face of the mailpiece envelope at a “print station”.

Finished mailpieces may then be passed along to a stacking station 28, which generally includes an on-edge stacker module configured to stack finished mailpieces vertically (i.e., on any of the edge of the finished mail from a flat, substantially horizontal position). The on-edge stacker module, in combination with the control system 14, is configured to control on-edge stacking of mailpieces and maintain a constant ideal stack pressure of a given stack of mailpieces in an autonomous manner. For example, the system 10 may include an exemplary on-edge stacker module as shown and described in co-owned U.S. patent application Ser. No. 18/585,479, filed Feb. 23, 2024, which is hereby incorporated by reference in its entirety.

Upon passing through the stacking station 28, finished mailpieces may then pass to a loading station 30 in which a given stack of finished mail is moved and loaded into a corresponding mail tray for subsequent processing (i.e., trays are transported to a postage facility, such as United States Postal Service (USPS) or any other presorting and shipping facility). For example, the loading station 30 may include one or more automated modules/assemblies for loading stacks of finished mail into a given mail tray. For example, in some embodiments, the loading station 30 may include automated means for dispensing mail trays and/or a robotic assembly for providing automated gripping and placement of a given stack of finished mail into a corresponding mail tray. For example, the system 10 may include such automated mechanism shown and described in co-owned U.S. patent application Ser. No. 18/424,671, filed Jan. 26, 2024, which is hereby incorporated by reference in its entirety.

As noted, the tray tag label applicator module 32 of the present application may be incorporated into a modular inserter and processing system or platform, such as the system/platform 10 of FIG. 1. As described in greater detail herein, the tray tag label applicator module 32 may be provided at the loading station 30 such that tray tag labels can be affixed to mail trays in an automated fashion and in conjunction with the loading of such mail trays with finished mail.

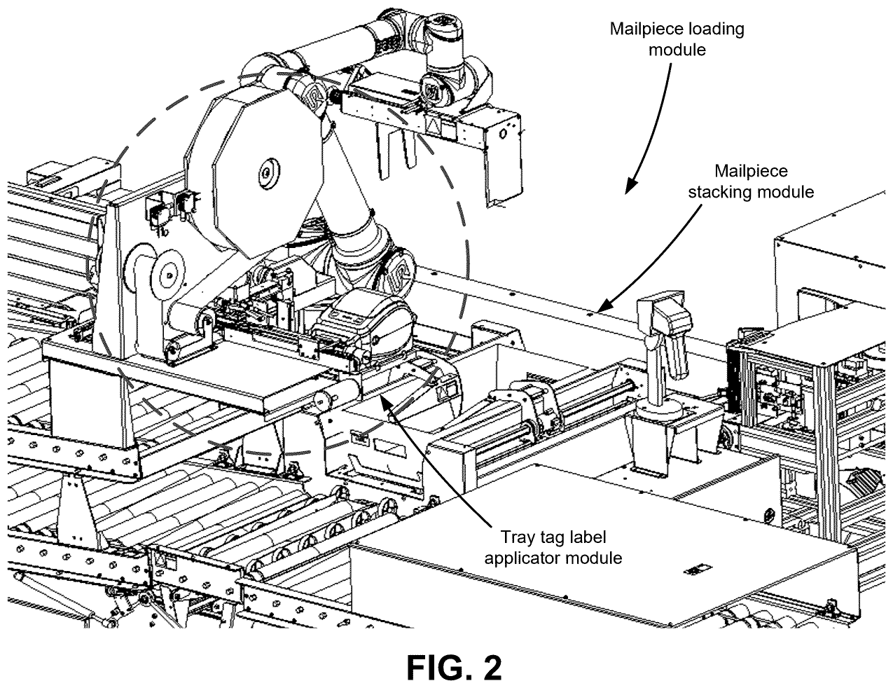

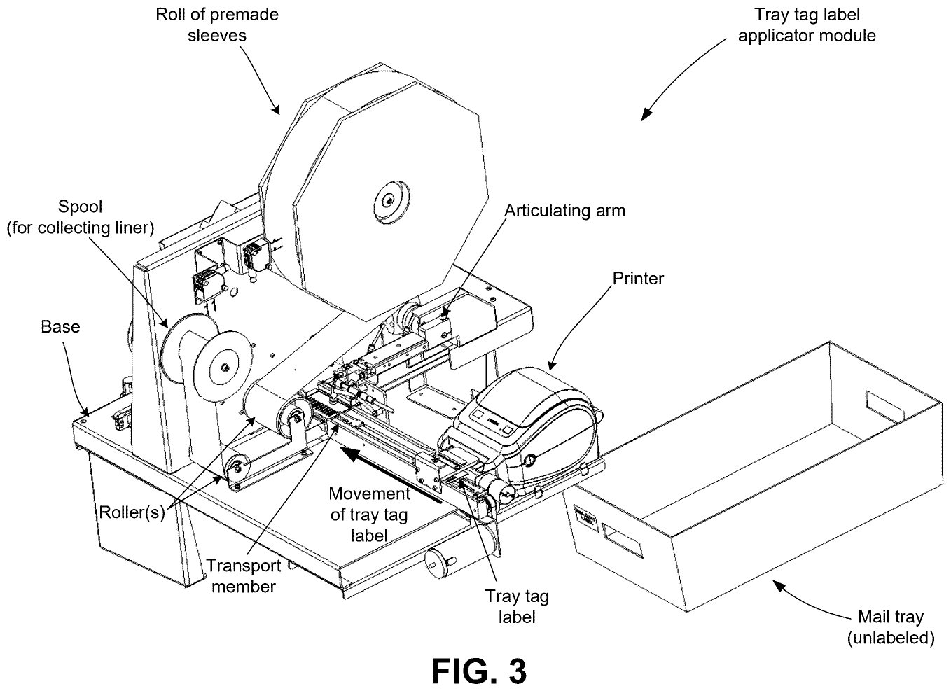

FIG. 2 is a perspective view of one embodiment of an exemplary tray tag label applicator module incorporated within an existing production mail inserter and processor assembly, specifically positioned relative to a mailpiece loading module (for loading finished mail provided via a mailpiece stacking module into corresponding mail trays). FIGS. 3-9 are various views showing the tray tag label applicator module of FIG. 2.

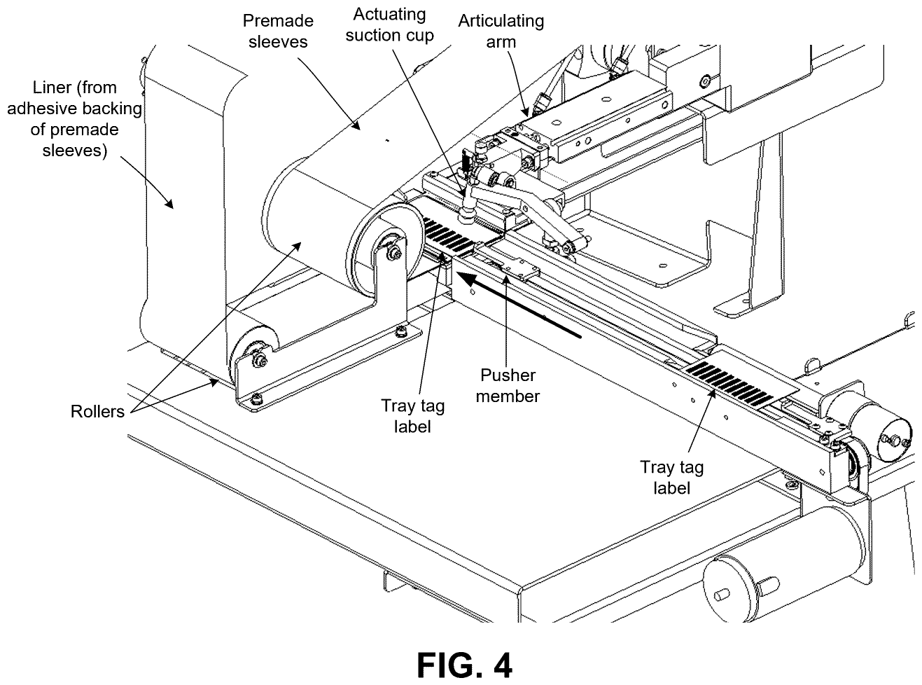

FIG. 3 is a perspective view of the tray tag label applicator module illustrating various components thereof. FIG. 4 is an enlarged view showing portions of the tray tag label inserter assembly of the tray tag label applicator module in greater detail.

As shown, the tray tag label applicator module includes tray tag label inserter assembly configured to sequentially receive a supply of a plurality of tray tag labels and automatically insert each tray tag label into a corresponding one of a plurality of sleeves. The tray tag label applicator module system further includes an applicator assembly (comprising an actuating arm including an end effector comprising a suction member) operably coupled to the tray tag label inserter assembly and configured to automatically affix each sleeve (that has been loaded with a corresponding tray tag label) to a corresponding one of a plurality of mail trays.

The tray tag labels may either be printed on demand or be pre-printed and provided to the system. For example, in one embodiment, the system may include a printer operably coupled to the transport member and configured to print tray tag information on the plurality of tray tag labels on demand. In addition to printing tray tag information on the tray tag labels, the printer may also be configured to cut each of the plurality of tray tag labels to size. Accordingly, by incorporating a printer into the system (for on-demand printing of information for each tag) information on a given tag label can be used to introduce a feedback step to the process, enabling the updating of tray tag data with the correct information necessary for mail induction into the postal mailstream. This can be facilitated when trays are automatically filled using an automated device including tray tagging and printing.

The tray tag label inserter assembly may generally be loaded with a supply of a plurality of premade sleeves and is configured to position a given one of the plurality of premade sleeves into alignment with a pathway of the plurality of tray tag labels. For example, in the illustrated embodiment, the plurality of tray tag labels may be provided to the tray tag label inserter assembly via a transport member. In particular, the tray tag labels are moved along, in a serial fashion, via the transport member towards to the tray tag label inserter assembly to then be inserted into a corresponding one of the plurality of sleeves.

In the illustrated embodiment, the transport member includes a pusher member provided between the printer and the tray tag label inserter assembly. The pusher member is configured to translate along a length of track in a reciprocating motion (i.e., in a substantially horizontal direction relative to the printer and the tray tag label inserter assembly). The pusher member is configured to engage an edge of a tray tag label from the printer and push the tray tag label towards the tray tag label inserter assembly and subsequently into a corresponding sleeve.

The tray tag label inserter assembly is configured to index each cycle of movement of the plurality of premade sleeves a distance equal to a width of each premade sleeve to thereby cause each premade sleeve to sequentially align with a corresponding one of the plurality of tray tag labels for subsequent insertion thereof.

The tray tag label inserter generally includes an actuating suction cup configured to engage and lift a top panel of a given one of the premade sleeves to thereby widen an opening of the given one of the premade sleeves. In some embodiments, the tray tag label inserter may also include an arm member that includes a flange (or finger-like member) configured to engage and cause movement of a corresponding one of the plurality of tray tag labels towards the opening and into the given one of the premade sleeves.

For example, there is a tray tag label insertion area, in which the suction cup is actuated up and down relative to a given sleeve placed within the tray tag label insertion area. Prior to insertion of a given tray tag label, the suction cup moves down, acquires, and lifts a top panel of a given sleeve using a vacuum force. After the top panel is lifted, the pusher member completes the insertion by advancing the tray tag label towards the opening of the given sleeve. As previously described, the tray tag label inserter may also include an arm member, wherein said arm member is able to moves in a direction towards an open of the given sleeve and inserts a flange or finger-like member into the opening of the sleeve to thereby guide the incoming tray tag label.

In some embodiments, the plurality of premade sleeves may include an adhesive backing covered by a liner such that, upon engagement of the applicator assembly with a loaded premade sleeve, liner is stripped from the loaded premade sleeve. More specifically, as the web of sleeves indexes, liner strips from the back of the sleeves by moving around a set of smaller diameter rollers and rewinding onto a spool. However, it should be noted that, in some embodiments, the module may include an adhesive applicator for applying an adhesive to a loaded premade sleeve prior to the applicator assembly affixing the loaded premade sleeve to the corresponding one of a plurality of mail trays.

Upon a given sleeve being loaded with a tray tag label, the web of sleeves indexes and thereby positions the loaded sleeve relative to the applicator assembly to be subsequently affixed to a mail tray. As illustrated in the drawings, the roll of premade sleeves, which may be supplied by the manufacturer, is mounted directly on tray tag label inserter assembly. A smaller rewind roll (or spool) is provided for collecting the paper liner. During operation, the smaller rewind roll may be operably coupled to a servo motor, for example, to thereby pull and control the motion of the premade sleeves with paper liner, advancing just one sleeve at a time, while the roll of premade sleeves with paper liner may be operably coupled to a second servo motor to aid in controlling tension of the paper liner material, wherein proper tension allows for improving the control over the sleeves to aid in the peeling of paper liner from the premade sleeves. The assembly may further include one or more sensors for collecting data to be used in controlling the speed of movement of the smaller rewind roll and/or the roll of premade sleeves. For example, to control the rotational speed of the two different rolls of material (i.e., the roll of premade sleeves and the collected liner material), the assembly may include two analog sensors, one sensor for the roll of premade sleeves with liner paper and another sensor for the roll with just the paper liner, each sensor being configured to constantly measure the diameters of each roll independently, wherein such measurements are used to determine the appropriate speed of movement of the web of sleeves.

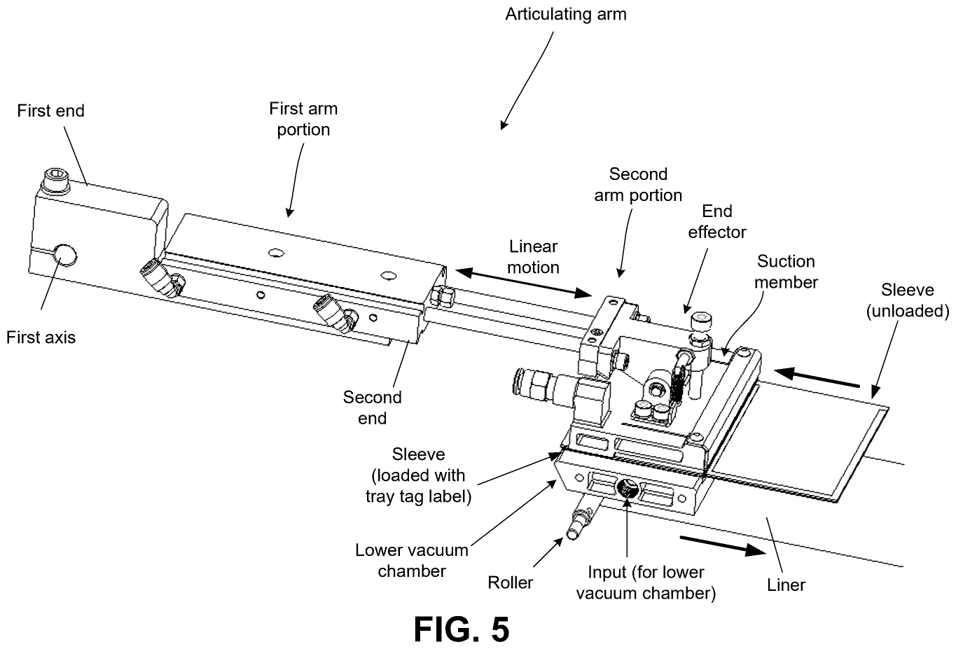

As will be described in greater detail herein with respect to FIGS. 5-8, the applicator assembly includes an articulating arm including an end effector at a distal portion thereof and having a suction member mounted thereto, the articulating arm being configured to move between a loading position and a delivery position.

The articulating arm may be controlled via a motorized mechanism (for controlling movement of the actuating arm between loading and delivery positions and any position therebetween). It should be further noted that the suction member, shown in the form of a vacuum plenum, is operatively coupled to a vacuum source. When the articulating arm is in the loading position, the suction member is positioned proximate to a leading one of the plurality of sleeves loaded with a corresponding tray tag label and ready to pick up the loaded sleeve. When the articulating arm is in the delivery position, the suction member is brought into position relative to a corresponding one of the plurality of mail trays to thereby cause the loaded sleeve (to which the suction member is engaged with) to be affixed, via an adhesive, to a portion of a corresponding one of the plurality of mail trays. Upon engagement between the loaded sleeve and the mail tray, the vacuum force is released so as to allow the suction member to disengage from the loaded sleeve and move back to the loading position to engage the next loaded sleeve to be subsequently applied to the next mail tray.

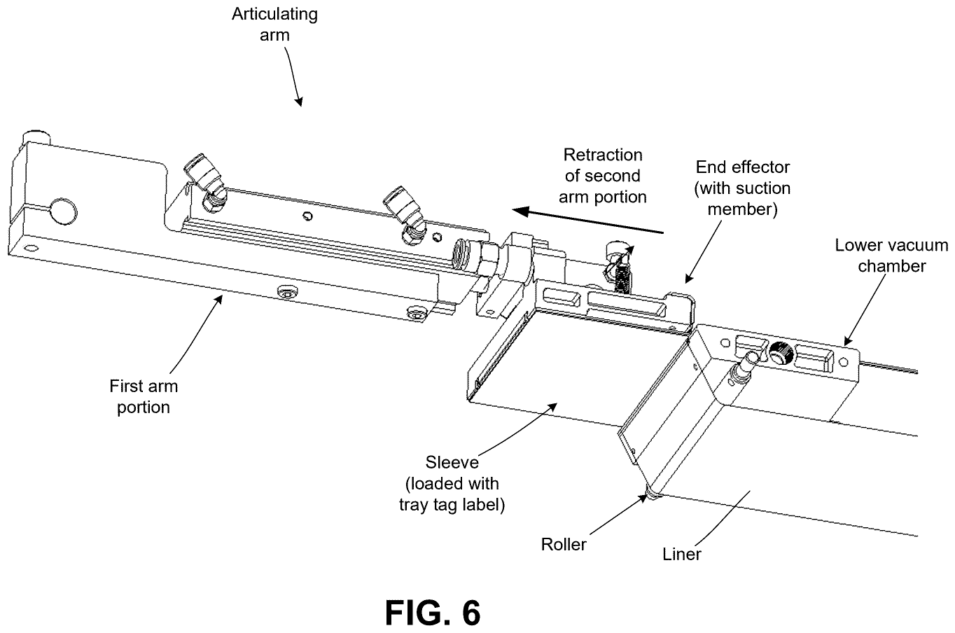

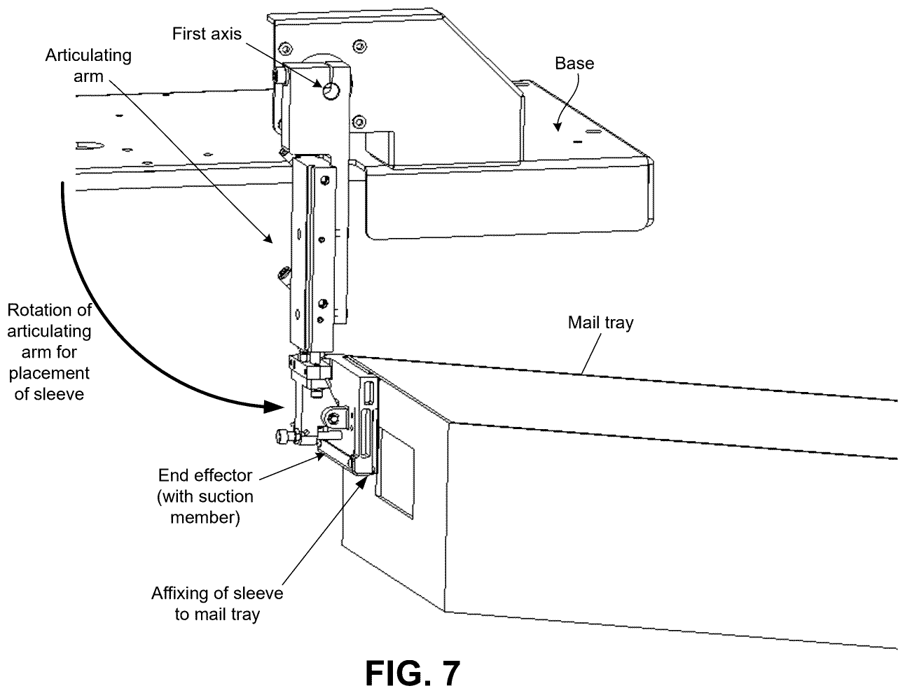

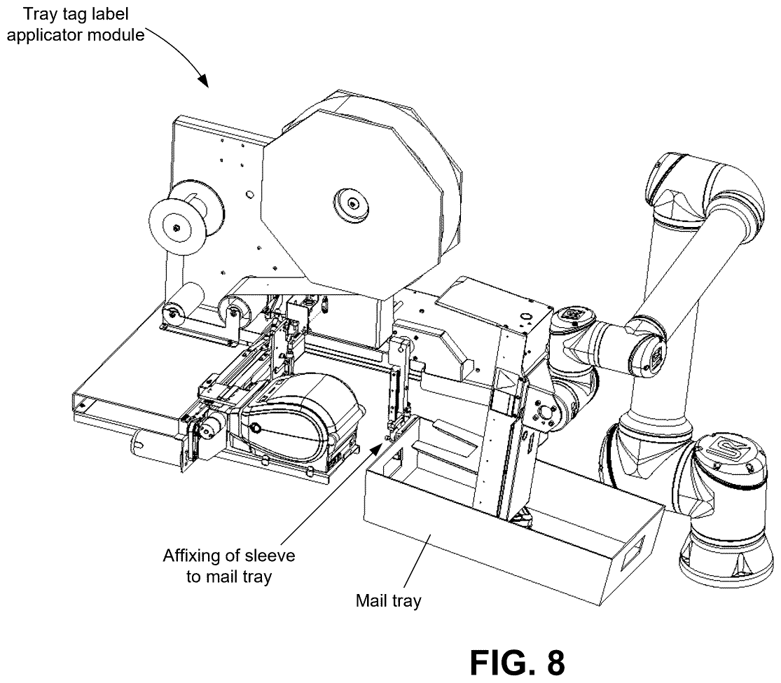

FIG. 5 is an enlarged view showing the articulating arm of the applicator assembly in greater detail, including illustrating the articulating arm in a loading position. FIGS. 6 and 7 illustrate retraction of the end effector of the articulating arm (FIG. 6) and subsequent movement of the articulating arm from a loading position to a delivery position (FIG. 7) for subsequently affixing a sleeve loaded with a corresponding tray tag label to a corresponding one of a plurality of mail trays. FIG. 8 shows the applicator assembly affixing a sleeve loaded with a corresponding tray tag label to a corresponding mail tray.

As shown, the articulating arm comprises a first arm portion and a second arm portion coupled to one another. The first arm portion includes a first end rotatably coupled to a base and is configured to rotate about a first axis relative to the base. The second arm portion extends from a second end of the first arm portion and is configured to move between a retracted position and an extended position relative to the second end of the first arm portion. In particular, the articulating arm may include a linear actuator mechanism configured to move the second arm portion between the retracted and extended positions. The second arm portion includes an end effector provided at a distal end thereof, wherein the end effector includes the suction member mounted thereto.

Upon a given sleeve being loaded with a tray tag label, the web of sleeves indexes and thereby positions the loaded sleeve under the suction member. For example, referring to FIG. 5, when the articulating arm is in the loading position, the first and second arm portions are substantially aligned with one another and substantially parallel to the base, and the second arm portion is in the extended position, such that the suction member is positioned proximate to a leading one of the plurality of sleeves loaded with a corresponding tray tag label. Upon application of a sufficient vacuum force, the suction member lifts the leading one of the plurality of sleeves loaded with a corresponding tray tag label into engagement therewith so as to allow subsequent conveyance thereof.

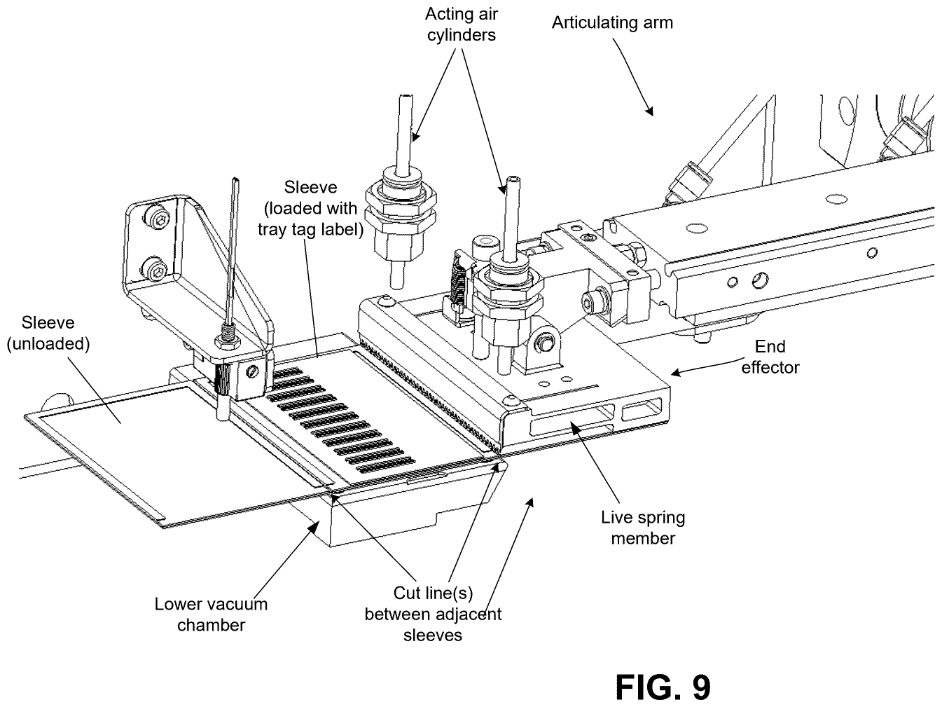

As shown, a vacuum chamber may be positioned under the sleeve that is staged for insertion of a corresponding tray tag label. The vacuum chamber (also referred to herein as lower vacuum chamber) serves various functions. In particular, the vacuum chamber may be supplied with a vacuum force (via the input) and, upon application of a sufficient vacuum force, the vacuum chamber is able to maintain a bottom portion or panel of the sleeve down while a top portion or panel of the sleeve is lifted (via the actuating suction cup) during insertion of a corresponding one of the tray tag labels into the sleeve. Furthermore, the vacuum chamber is able to the sleeve web from shifting during cutting of the sleeves (said cutting described in greater detail herein, particularly with respect to FIG. 9), which ensures accurate positioning for the next sleeve web advance cycle.

After a loaded sleeve is positioned under the suction member and acquired by a vacuum force, the loaded sleeve is then removed from the web of sleeves (e.g., removal of the liner from the adhesive backing of loaded sleeve) based on movement of the second arm portion and/or movement of the web of sleeves.

For example, in one embodiment, the second arm portion moves from the extended position to the retracted position, resulting in the end effector being drawn back towards the first arm portion, while the web of sleeves are advanced. In particular, it should be noted that the speed of retraction of the second arm portion may be the same, or substantially the same, as the speed at which the sleeves are advanced. In turn, the liner wraps around a tight radius (at the roller shown in FIGS. 5 and 6), while the loaded sleeve acquired by the suction member continues in a linear direction, thereby separating the loaded sleeve from the liner. Such synchronized motion effectively lifts the leading edge of the loaded sleeve from the liner while keeping the trailing edge of the sleeve motionless, thereby minimizing the force to strip the sleeve from the liner.

In another embodiment, once the loaded sleeve is acquired by the suction member, the web of sleeves may be advanced, in which the liner wraps around a tight radius (at the roller shown in FIGS. 5 and 6), while the premade sleeves continue in a horizontal direction while being held onto the vacuum of the suction member. Once the loaded sleeve is advanced on length, a cutting mechanism (described in greater detail herein) may be actuated to separate the loaded sleeve from the immediately adjacent unloaded sleeve.

Upon separation of the loaded sleeve from the liner, as shown in FIG. 6), the first arm portion rotates about the first axis towards a perpendicular and lowered position relative to the base, while maintaining the second arm portion in the retracted position so as to allow the second arm portion to clear portions of the base and/or other portions of the liner and tray tag label inserter assembly. In turn, the suction member is brought into position relative to a corresponding one of the plurality of mail trays to thereby cause the leading one of the plurality of sleeves loaded with a corresponding tray tag label to engage and be affixed, via an adhesive, to a portion of a corresponding one of the plurality of mail trays. FIGS. 7 and 8 show the applicator assembly affixing a sleeve loaded with a corresponding tray tag label to a corresponding mail tray.

At this moment, the vacuum in the suction member is turned off and the actuating arm begins coordinated movement back to a loading position. In particular, the first arm portion rotates about the first axis towards a substantially parallel position relative to the base while maintaining the second arm portion in the retracted position so as to allow the second arm portion to clear portions of the base and/or other portions of the assembly. Then, the second arm portion moves to the extended position to thereby position the end effector (and suction member) for receipt of the next loaded sleeve.

In some embodiments, the applicator assembly may include a means for cutting, or otherwise separating, sleeves from one another during the insertion and application phase. In particular, the sleeves provided on the roll may require cutting, separating, or otherwise bursting a preformed area between immediately adjacent sleeves. For example, perforated boundaries may be formed between immediately adjacent sleeves.

FIG. 9 is an enlarged view showing an exemplary embodiment of an end effector of the articulating arm having a cutting member providing thereon for cutting perforated portions or boundaries between each sleeve. For example, the end effector may include a serrated blade mounted on a live spring on the suction member, which may be acted on externally via an air cylinder, to thereby cut through performed areas between immediately adjacent sleeves. In another embodiment, a Guillotine-style cutting mechanism may be used.

Accordingly, the system of the present invention provides an autonomous manner in which tray tag labels are affixed to mail trays, reducing risk of errors in the workflow and thereby improving economic and operational efficiency of labeling mail trays for subsequent processing (i.e., placement of a given stack of finished mail into the trays, in which trays are then transported to a postage facility, such as United States Postal Service (USPS) or any other presorting and shipping facility).

### Alternative Embodiment(s)

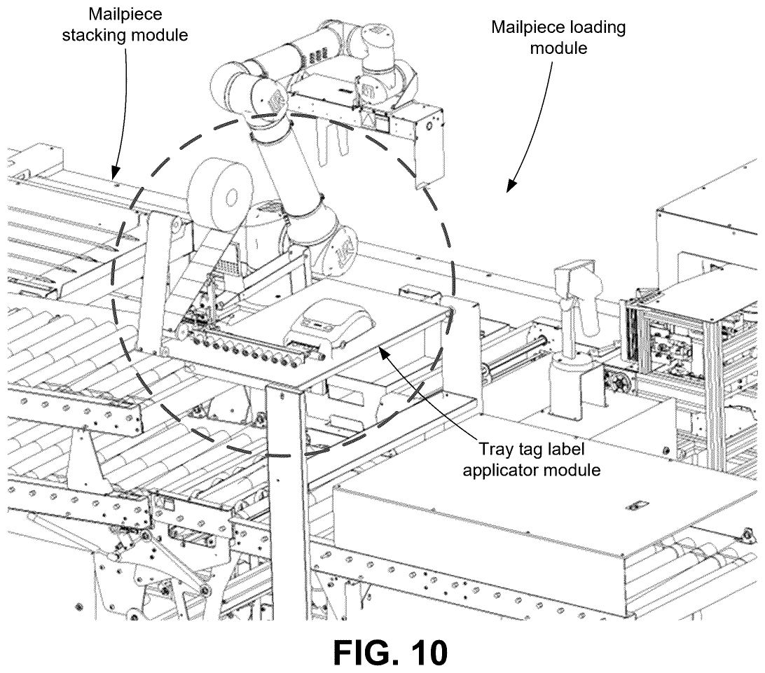

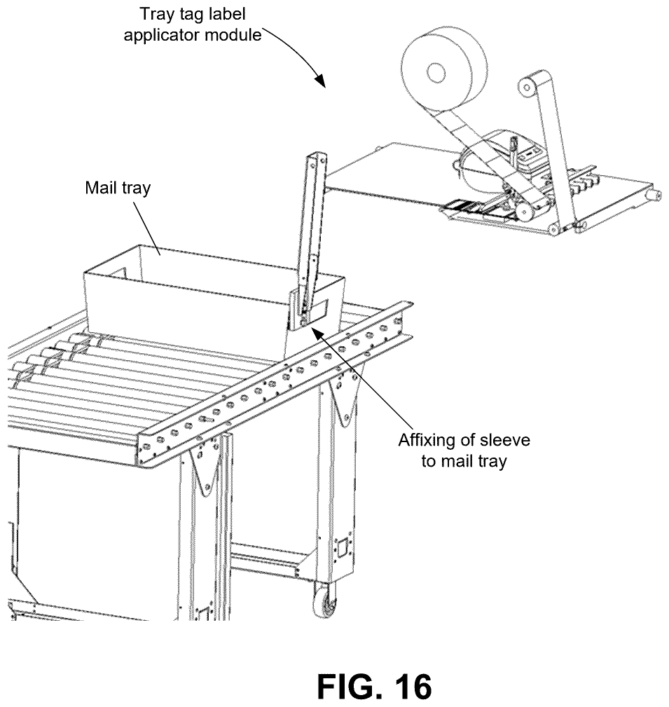

FIGS. 10-16 show an alternative embodiment of a tray tag label applicator module. In particular, FIGS. 10-16 generally illustrate alternative embodiments of the transport member(s) and the articulating arm of the tray tag label insert assembly.

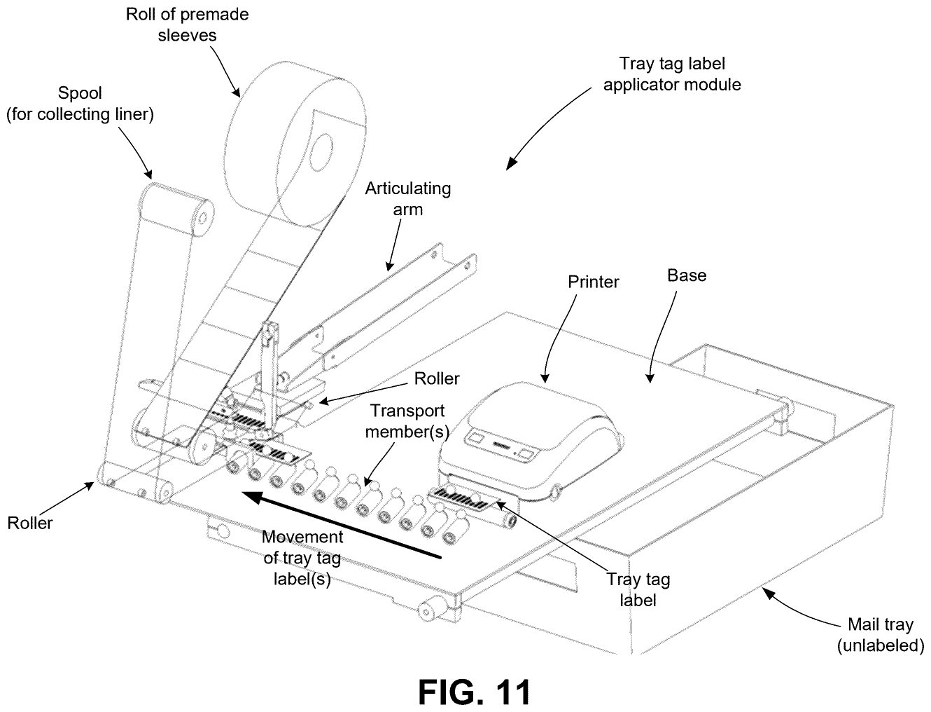

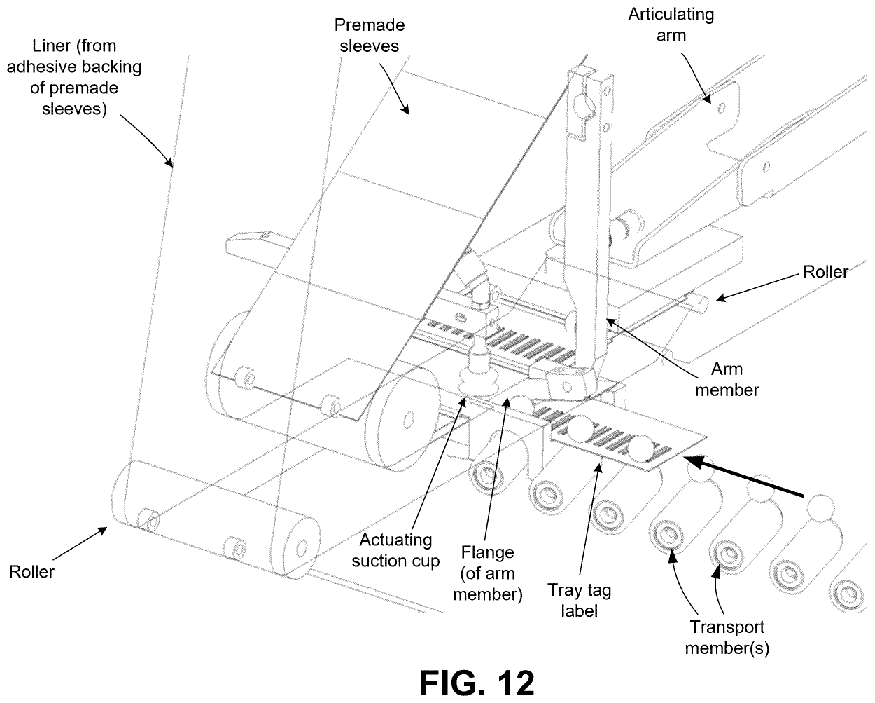

FIG. 10 is a perspective view of an exemplary alternative tray tag label applicator module consistent with the present disclosure. FIG. 11 is a perspective view of the tray tag label applicator module of FIG. 10 illustrating various components thereof. FIG. 12 is an enlarged view showing portions of the tray tag label inserter assembly of the tray tag label applicator module of FIG. 10 in greater detail.

As shown, the tray tag label applicator module of FIG. 10 is general similar to the tray tag label applicator module of FIG. 2, but includes alternative embodiments of at least the transport member(s) and the articulating arm of the tray tag label insert assembly. For example, the plurality of tray tag labels may be provided to the tray tag label inserter assembly via a series of rollers, which may be motorized. The tray tag labels are moved along in a serial fashion, via the rollers, towards to the tray tag label inserter assembly to then be inserted into a corresponding one of the plurality of sleeves.

The tray tag label inserter includes an actuating suction cup and an arm member. The actuating suction cup is configured to engage and lift a top panel of a given one of the premade sleeves to thereby widen an opening of the given one of the premade sleeves. The arm member includes a flange (or finger-like member) configured to engage and cause movement of a corresponding one of the plurality of tray tag labels towards the opening and into the given one of the premade sleeves. For example, there is a tray tag label insertion area, in which the suction cup is actuated up and down relative to a given sleeve placed within the tray tag label insertion area. Prior to insertion of a given tray tag label, the suction cup moves down, acquires, and lifts a top panel of a given sleeve using a vacuum force. After the top panel is lifted, the arm member moves in a direction towards an open of the given sleeve and inserts a flange or finger-like member into the opening of the sleeve to thereby guide the incoming tray tag label. The transport member completes the insertion by advancing the tray tag label towards the opening of the given sleeve.

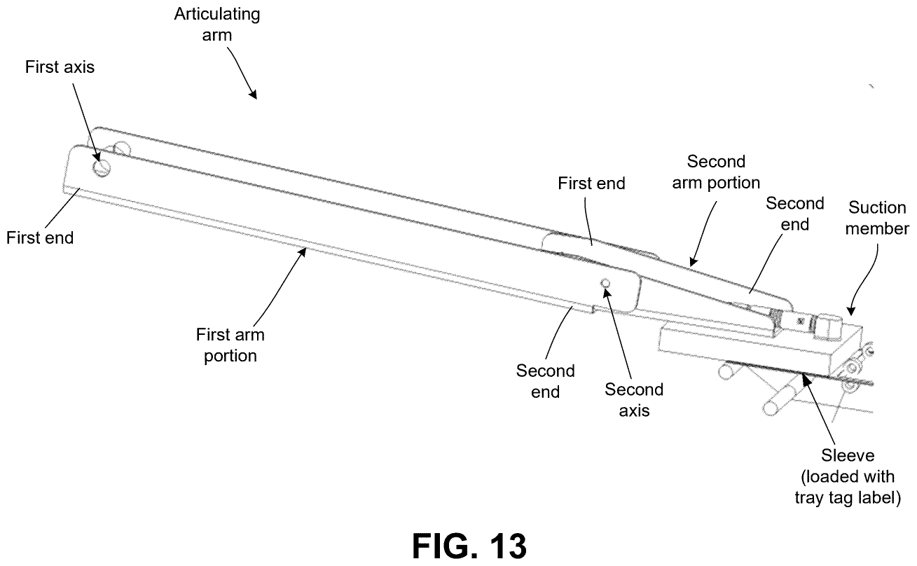

Upon a given sleeve being loaded with a tray tag label, the web of sleeves indexes and thereby positions the loaded sleeve relative to the applicator assembly to be subsequently affixed to a mail tray, as shown and described with respect to FIGS. 13-16.

For example, an alternative embodiment of an articulating arm is shown. FIG. 13 is an enlarged view showing the alternative embodiment of the articulating arm of the applicator assembly in greater detail. The articulating arm comprises a first arm portion and a second arm portion rotatably coupled to one another. For example, the first arm portion includes a first end rotatably coupled to a base and is configured to rotate about a first axis relative to the base and includes a second opposing end rotatably coupled to a first end of the second arm portion. The second arm portion is configured to rotate about a second axis relative to the first arm portion. The suction member is mounted to the second arm portion, notably at a distal end thereof.

Upon a given sleeve being loaded with a tray tag label, the web of sleeves indexes and thereby positions the loaded sleeve under the suction member. When the articulating arm is in the loading position, the suction member is positioned proximate to a leading one of the plurality of sleeves loaded with a corresponding tray tag label and, upon application of a sufficient vacuum force, the suction member lifts the leading one of the plurality of sleeves loaded with a corresponding tray tag label into engagement therewith so as to allow subsequent conveyance thereof.

For example, after a loaded sleeve is positioned under the suction member and acquired by a vacuum force, the first and second portions of the articulating arm may translate in a particular series of movements to ensure that the loaded sleeve is efficiently removed from the web of sleeves (for removal of the liner from the adhesive backing with little force needed) while ensuring that the loaded sleeve is accurately affixed to the corresponding portion on a mail tray. For example, when the articulating arm is in the loading position, the first and second arm portions are substantially aligned with one another and substantially parallel to the base.

Movement of the articulating arm from the loading position to the delivery position may include an initial step of the first arm portion rotating in an upward motion (upward relative to the base) while the second arm portion rotates in a downward motion (downward relative to the base). Such synchronized motion effectively lifts the leading edge of the loaded sleeve from the liner while keeping the trailing edge of the sleeve motionless, thereby minimizing the force to strip the sleeve from the liner.

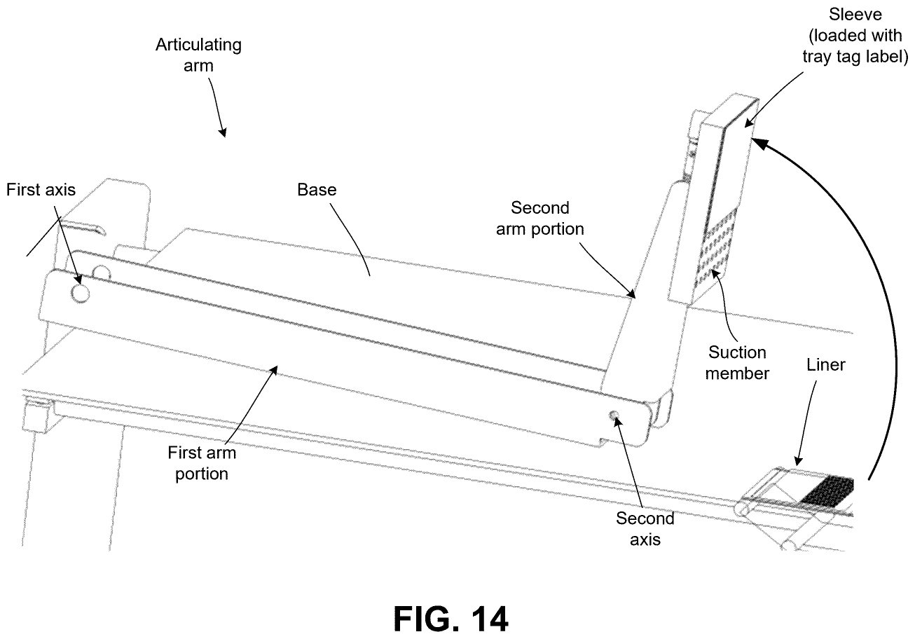

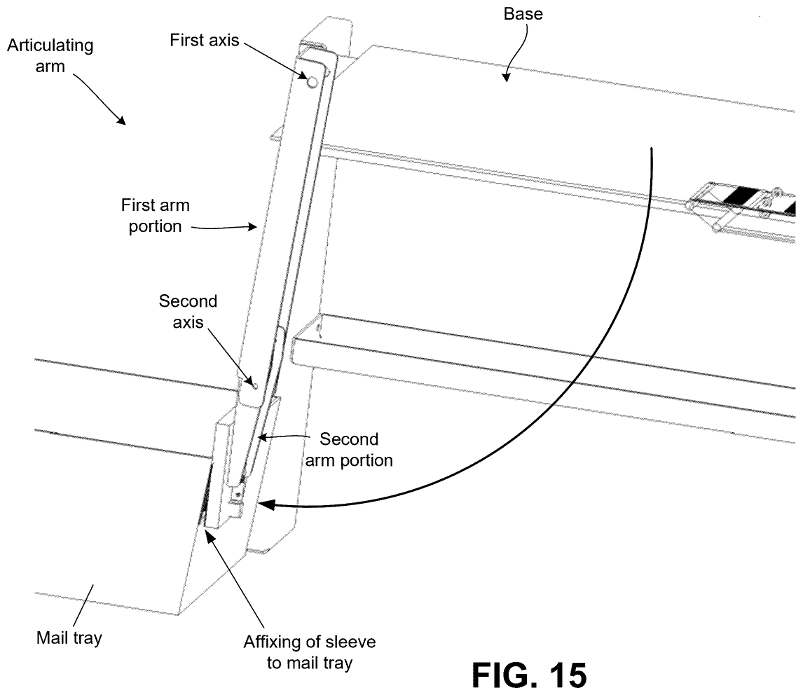

Upon separation of the loaded sleeve from the liner, the first arm portion stops rotational movement and the second arm portion reverses rotational movement and rotates in an upward motion (shown in FIG. 14). Once vertical, the second arm portion stops movement and the first arm portion starts rotational motion in a downward direction and after the first arm portion rotates downward to about 45 degrees, the second arm portion rotates in a downward motion to align with the first arm portion prior to the suction member contacting and pressing the loaded sleeve against a side of the mail tray (shown in FIG. 15). At this moment, the vacuum in the suction member is turned off and the actuating arm begins coordinated movement back to a loading position. In particular, the second arm portion returns to a perpendicular position relative to the first arm portion and the first arm portion rotates in an upward direction (counterclockwise) to return to a substantially parallel position (relative to the base) while the second arm portion is maintained in the perpendicular position. Then, the second arm portion rotates in a downward direction (to become substantially aligned with the first arm portion) and positioning the suction member for receipt of the next loaded sleeve.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location.

The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S. C. § 101.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A system for providing autonomous application of tray tag labels to mail trays, the system comprising:
a transport member for transporting a plurality of tray tag labels;
tray tag label inserter assembly configured to sequentially receive the plurality of tray tag labels from the transport member and automatically insert each tray tag label into a corresponding one of a plurality of sleeves; and
an applicator assembly configured to automatically affix each sleeve loaded with a corresponding tray tag label to a corresponding one of a plurality of mail trays.

2. The system of claim 1, wherein the tray tag label inserter assembly is loaded with a supply of a plurality of premade sleeves and configured to position a given one of the plurality of premade sleeves into alignment with a pathway of the plurality of tray tag labels.

3. The system of claim 2, wherein tray tag label inserter assembly is configured to index each cycle of movement of the plurality of premade sleeves a distance equal to a width of each premade sleeve to thereby cause each premade sleeve to sequentially align with a corresponding one of the plurality of tray tag labels for subsequent insertion thereof.

4. The system of claim 3, wherein the tray tag label inserter assembly comprises an actuating suction cup configured to engage and lift a top panel of a given one of the premade sleeves to thereby widen an opening of the given one of the premade sleeves.

5. The system of claim 3, wherein the tray tag label inserter assembly comprises an arm member comprising a flange configured to engage and cause movement of a corresponding one of the plurality of tray tag labels towards the opening and into the given one of the premade sleeves.

6. The system of claim 2, wherein each of the plurality of premade sleeves comprises an adhesive backing covered by a liner such that, upon engagement of the applicator assembly with a loaded premade sleeve, liner is stripped from the loaded premade sleeve.

7. The system of claim 2, further comprising an adhesive applicator for applying an adhesive to the loaded premade sleeve prior to the applicator assembly affixing the loaded premade sleeve to the corresponding one of a plurality of mail trays.

8. The system of claim 1, wherein said applicator assembly comprises an articulating arm comprising an end effector including a suction member mounted thereon, the articulating arm being configured to move between a loading position and a delivery position;
wherein, when the articulating arm is in the loading position, the suction member is positioned proximate to a leading one of the plurality of sleeves loaded with a corresponding tray tag label and, upon application of a sufficient vacuum force, the suction member lifts the leading one of the plurality of sleeves loaded with a corresponding tray tag label into engagement therewith so as to allow subsequent conveyance thereof; and
wherein, when the articulating arm is in the delivery position, the suction member is brought into position relative to a corresponding one of the plurality of mail trays to thereby cause the leading one of the plurality of sleeves loaded with a corresponding tray tag label to engage and be affixed, via an adhesive, to a portion of a corresponding one of the plurality of mail trays.

9. The system of claim 8, wherein, when the articulating arm is in the delivery position, the vacuum force is released so as to allow the suction member to disengage from the leading one of the plurality of sleeves loaded with a corresponding tray tag label.

10. The system of claim 8, wherein the articulating arm comprises a first arm portion and a second arm portion coupled to one another.

11. The system of claim 10, wherein the first arm portion comprises:
a first end rotatably coupled to a base and is configured to rotate about a first axis relative to the base; and
a second end coupled to the second arm portion.

12. The system of claim 11, wherein the second arm portion extends from the second end of the first arm portion and is configured to move between a retracted position and an extended position relative to the second end of the first arm portion via a linear actuator mechanism.

13. The system of claim 12, wherein the end effector including the suction member is mounted to the second arm portion.

14. The system of claim 13, wherein:
when the articulating arm is in the loading position, the first and second arm portions are substantially aligned with one another and substantially parallel to the base, and the second arm portion is in the extended position; and
when the articulating arm is in the delivery position, the first and second arm portions are substantially aligned with one another and substantially perpendicular to the base, and the second arm is in the retracted position.

15. The system of claim 14, wherein, movement from the loading position to the delivery position is performed in the following motions:
the second arm portion moves from the extended position to the retracted position relative to the first arm portion; and
the first arm portion rotates about the first axis towards a perpendicular and lowered position relative to the base while maintaining the second arm portion in said retracted position so as to allow the second arm portion to clear portions of the base and/or other portions of the system to thereby cause the suction member to be brought into position relative to a corresponding one of the plurality of mail trays to thereby cause the leading one of the plurality of sleeves loaded with a corresponding tray tag label to engage and be affixed, via an adhesive, to a portion of a corresponding one of the plurality of mail trays.

16. The system of claim 14, wherein, movement from the delivery position to the loading position is performed in the following motions:
the first arm portion rotates about the first axis towards a substantially parallel position relative to the base while maintaining the second arm portion in said retracted position so as to allow the second arm portion to clear portions of the base and/or other portions of the system; and
the second arm portion moves to the extended position to thereby position the suction member proximate to a leading one of the plurality of sleeves loaded, or to be loaded, with a corresponding tray tag label.

17. The system of claim 1, wherein the transport member comprises a series of rollers or a pusher member configured to move the plurality of tray tag labels towards the tray tag label inserter assembly in a serial fashion.

18. The system of claim 17, wherein the pusher member is configured to translate along a length of track in a reciprocating motion in a substantially horizontal direction relative to the tray tag label inserter assembly, the pusher member being configured to engage an edge of a tray tag label and push the tray tag label towards the tray tag label inserter assembly and subsequently into a corresponding sleeve.

19. The system of claim 1, further comprising a printer operably coupled to the transport member and configured to print indicia on the plurality of tray tag labels on demand.

20. The system of claim 19, wherein the printer is further configured to cut each of the plurality of tray tag labels to size.
